(19) United States
(12) Patent Application Publication
(10) Pub. No.: US 2017/0124361 A1
(43) Pub. Date: May 4, 2017

(54) ARRANGEMENT FOR, AND METHOD OF, CONFIGURING AN RFID READER TO SCAN RFID TAGS IN COMPLIANCE WITH REGULATIONS OF A PARTICULAR REGULATORY REGION OF OPERATION

(71) Applicant: SYMBOL TECHNOLOGIES, LLC, LINCOLNSHIRE, IL (US)

(72) Inventor: SAJAN WILFRED, KOLLAM (IN)

(21) Appl. No.: 14/929,487

(22) Filed: Nov. 2, 2015

(51) Int. Cl. G06K 7/10; G06K 19/07

(52) U.S. Cl. CPC G06K 7/10237; G06K 19/0723

(57) ABSTRACT

A radio frequency (RF) identification (RFID) reader is configured to scan RFID tags in compliance with regulations of a particular regulatory region of operation. An RF module in the reader listens for, and receives, over a wireless channel, a broadcast message that identifies the particular regulatory region in which the reader is situated. A controller in the reader determines the particular regulatory region in the received broadcast message, and automatically configures the reader to operate in accordance with the regulations of the particular regulatory region upon such determination.

### BACKGROUND OF THE INVENTION

The present disclosure relates generally to an arrangement for, and a method of, configuring a radio frequency (RF) identification (RFID) reader to scan RFID tags in compliance with the regulations of a particular regulatory region of operation and, more particularly, to an RFID reader that can accurately and automatically configure itself to the particular regulatory region in which the reader is situated.

RFID systems are well known and are commonly utilized for item locating, item tracking, item identification, and inventory control in manufacturing, warehouse, and retail environments. Briefly, an RFID system includes two primary components: a reader (also known as an interrogator), and a tag (also known as a transponder). The tag is a miniature device associated with an item to be monitored and is capable of responding, via a tag antenna, to an electromagnetic wave wirelessly propagated by a reader antenna of the reader. The tag responsively generates and wirelessly propagates a return electromagnetic wave back to the reader antenna. The return electromagnetic wave is modulated in a manner that conveys identification data (also known as a payload) from the tag back to the reader. The identification data can then be stored, processed, displayed, or transmitted by the reader as needed. The return electromagnetic wave can also be used to determine the true bearing and location of the tag in a controlled area.

RFID readers typically operate in the Industrial, Scientific, and Medical (ISM) frequency band from about 860 MHz to about 960 MHz in accordance with the global standard known as EPCglobal UHF Gen 2 (ISO/IEC 18000-6C). Local operation and deployment of RFID readers are governed by regional regulatory bodies, such as the Federal Communications Commission (FCC) in the United States, the European Telecommunications Standards Institute (ETSI) in Europe, and scores of other regional regulatory entities for individual countries who specify and enforce unique local requirements for usable sub-bands, guidelines for interference mitigation, maximum allowable reader transmission power levels, and so forth.

Each RFID reader, therefore, must be configured to operate in each such regulatory region to avoid any local regulatory non-compliance. It would be burdensome for a reader manufacturer to have to build a multitude of individual RFID readers pre-configured for each such regulatory region. Hence, one or more generic RFID readers are typically built and, at the time of RFID reader deployment, a local human operator needs to manually configure each individual reader to the correct local regulatory region/country in which the RFID reader is being operated. This is a critical step that needs to done correctly and consistently to avoid any regulatory non-compliance.

Experience has shown, however, that such manual configuration is not always immediately performed upon the first powering-up of the reader, thereby leading to a poor out-of-the box reader experience, and, after being performed, it is not always done correctly, or is not done for all the readers being deployed in a particular venue. This issue is more severe for RFID readers that have a limited user interface, e.g., headless fixed readers and sled readers.

Accordingly, it is desired to eliminate any chance of regulatory violation, and to improve the overall operating performance and user experience of the RFID reader.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a partly-diagrammatic, overall view of an arrangement for automatically configuring an RFID reader to scan RFID tags in compliance with the regulations of a particular regulatory region of operation in accordance with the present disclosure.

FIG. 2 is a block diagrammatic view of some of the components of FIG. 1.

FIG. 3 is a flow chart depicting steps performed in accordance with a method of the present disclosure.

Skilled artisans will appreciate that elements in the figures are illustrated for simplicity and clarity and have not necessarily been drawn to scale. For example, the dimensions and locations of some of the elements in the figures may be exaggerated relative to other elements to help to improve understanding of embodiments of the present invention.

The arrangement and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

One aspect of this disclosure relates to an arrangement for configuring an RFID reader to scan RFID tags in compliance with the regulations of a particular regulatory region or country of operation. The arrangement includes an RF module and a controller, both in the reader. The RF module listens for, and receives, over a wireless channel, a broadcast message that identifies the particular regulatory region in which the reader is situated. The controller determines the particular regulatory region in the received broadcast message, and automatically configures the reader to operate in accordance with the regulations of the particular regulatory region upon such determination.

Preferably, the RF module listens and receives the broadcast message over at least one Global System for Mobile communications (GSM) downlink channel. The RF module is operative for receiving the broadcast message in a range of frequencies between about 860 MHz and about 960 MHz. This designated range is not intended to limit the invention disclosed herein, because other frequency ranges are also contemplated. A base station periodically transmits the broadcast message over the GSM downlink channel. The broadcast message contains a plurality of data fields, and one of the data fields is a mobile country code identifier. The controller extracts the particular regulatory region from the mobile country code identifier, and this country identifier is used by the controller to automatically and correctly, without user involvement, configure the reader to operate in accordance with the regulations of the identified country.

Another aspect of this disclosure relates to a self-configuring RFID reader operative for scanning RFID tags in compliance with regulations of a particular regulatory region of operation. The reader includes an RF module for listening for, and for receiving, over a wireless channel, a broadcast message that identifies the particular regulatory region in which the reader is situated. The reader also includes a controller that determines the particular regulatory region in the received broadcast message, and automatically configures the reader to operate in accordance with the regulations of the particular regulatory region upon such determination.

A method of configuring an RFID reader to scan RFID tags in compliance with regulations of a particular regulatory region of operation, in accordance with still another aspect of this disclosure, is performed by listening for, and receiving, over a wireless channel, a broadcast message that identifies the particular regulatory region in which the reader is situated; by determining the particular regulatory region in the received broadcast message; and by automatically configuring the reader to operate in accordance with the regulations of the particular regulatory region upon such determination.

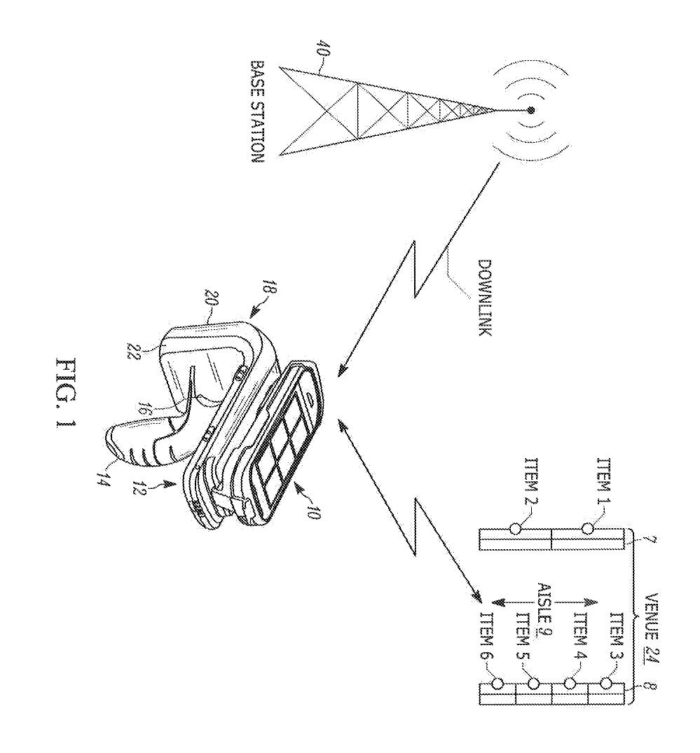

Turning now to FIG. 1 of the drawings, reference numeral 10 generally identifies a handheld RFID reader operative, in normal intended use, for interrogating and reading RFID tags associated with items 1-9 within its coverage range. As shown, the RFID-tagged items 1 and 2 are mounted on a shelving structure 7, and the RFID-tagged items 3-6 are mounted on another shelving structure 8 that is spaced from the shelving structure 7 by an aisle 9 in a venue 24, such as a warehouse environment. This illustrated layout of the RFID-tagged items 1-6 is merely exemplary, because many other layouts are comprehended by this disclosure.

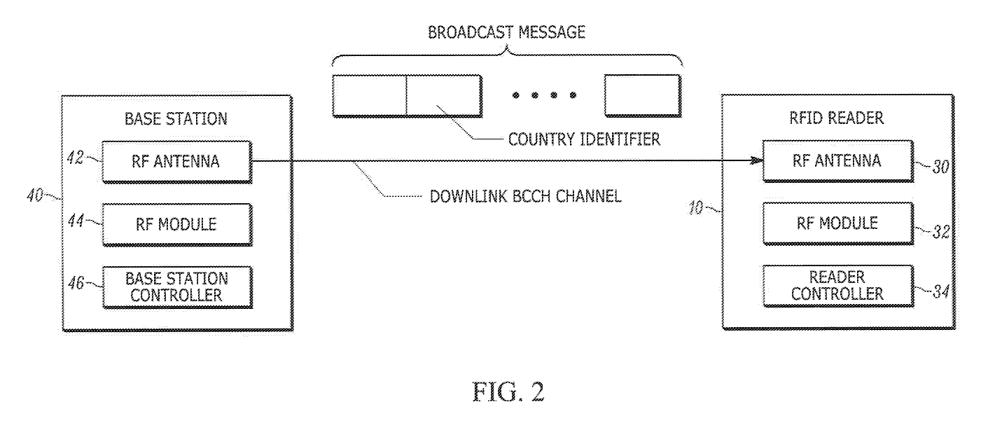

As also shown in FIG. 1, the reader 10 may include a display, a keypad, a touch panel, other input/output elements, or the like. This particular embodiment of the RFID reader 10 is mounted on a gun-shaped sled 12 having a handle 14 to be gripped and held by a user, a trigger 16 to be manually actuated by the user to initiate reading, and a front-mounted radome 18 having a front housing 20 and a rear housing 22 for containing therein an RF antenna 30 (see FIG. 2), which is naturally pointed toward, and forwardly faces, each intended target tag during normal handheld operation of the RFID reader 10. An RF module 32 (also, see FIG. 2), is operatively connected to the antenna 30 for forwardly transmitting electromagnetic waves to each RFID-tagged item 1-6 in its turn, and for receiving return electromagnetic waves from each RFID-tagged item 1-6, during operation. The illustrated gun-shaped configuration of the reader sled 12 is merely exemplary, because many other different reader configurations, both handheld and/or hands-free, both mobile and fixed, both with and without a sled, are comprehended by this disclosure.

As described above, prior to reading the RFID-tagged items 1-6, the RFID reader 10 needs to be initially configured to operate in each regulatory region or country in which the RFID reader 10 is situated to avoid any local regulatory non-compliance. Instead of the known technique of manually performing this configuration procedure, which is subject to human error, one aspect of this disclosure is directed to automatically and correctly configuring each RFID reader to operate in each regulatory region or country.

To that end, in a preferred embodiment, the RFID reader 10 uses the GSM wireless communications standard, which has a near ubiquitous worldwide deployment. By way of background, almost all countries operate wireless communications networks in either the GSM850 system (all of North America, and the Western side of South America) or the GSM900 system (the rest of the world). The GSM standard provides the protocols for a base station to broadcast messages to mobile communication devices over downlink channels, and to receive messages from the mobile communication devices over uplink channels. The frequency bands and channel allocations for the GSM850 and GSM900 systems are different and are set forth in the following Table 1:

TABLE 1

| System | Band | Uplink (MHz) | Downlink (MHz) | Channel number |
|---|---|---|---|---|
| GSM-850 | 850 | 824.2-849.2 | 869.2-893.8 | 128-251 |
| GSM-900 | 900 | 890.0-915.0 | 935.0-960.0 | 1-124 |

Each of the 124 channels in the uplink and downlink channels has a width of 200 kHz (0.2 MHz) and is identified and known by an Absolute Radio-Frequency Channel Number (ARFCN), which is a predefined code that specifies a pair of physical radio carriers used for transmission and reception, one for an uplink signal and one for a downlink signal. The following Table 2 specifies the uplink and downlink physical channels identified by the ARFCN:

TABLE 2

| | | Uplink Frequency | Downlink Frequency |
|---|---|---|---|
| System | ARFCN Range | (MHz) | (MHz) |
| GSM 900 | 1 . . . 124 | 890 + | 935 + |
| | | 0.2*ARFCN | 0.2*ARFCN |
| GSM 850 | 128 . . . 251 | 824.2 + | 869.2 + |
| | | 0.2*(ARFCN-128) | 0.2*(ARFCN-128) |

The GSM base station uses a broadcast control channel (BCCH), which is a point-to-multipoint, unidirectional, downlink channel in the air interface to the mobile devices. The base station periodically broadcasts system information messages that describe the identity, configuration and available features of the base station over the BCCH downlink channel. Each information message has multiple data fields containing specific parameters. One of the information messages in this BCCH downlink channel is called “System Information Type 3” and includes the following information elements:
Cell identity (CI) to identify any cell in a given location area
Location area identification:
   Mobile Country Code (MCC)
   Mobile Network Code (MNC)
   Location Area Code (LAC)
   Control channel description
Cell options
Cell selection parameters
Random access channel (RACH) control parameters
System information (SI) 3 rest octets indicating the existence of General Packet Radio Services (GPRS).

These information messages are repeated every 51 microframes in GSM parlance, which translates to every 235.4 microseconds. The above-noted “Mobile Country Code (MCC)” in each information message denotes the country or region of operation of the base station. Regulatory requirements for GSM mandates that the correct country code be assigned to, and transmitted by, each base station.

In accordance with this disclosure, the RF module 32 (see FIGS. 1-2) in the reader 10 is tuned to the frequency range of about 860 MHz to about 960 MHz, which is the overall frequency range of the downlink channels for both the GSM850 and GSM900 systems (see Table 1). The RF module 32 then passively probes, or listens on, one or more downlink channels, e.g., the BCCH downlink channel, until the RF module 32 receives a broadcast message, e.g., the information message containing a country or region of operation identifier, being transmitted by a GSM base station 40 (see FIGS. 1-2). The base station 40 has an RF antenna 42, an RF module 44, and a base station controller 46, preferably a programmed microprocessor, to control the periodic transmission of the broadcast message.

A reader controller 34, preferably a programmed microprocessor, in the reader 10 determines the country identifier by extracting and decoding the country or region of operation from the received broadcast message, and then automatically configures the reader 10 to operate in accordance with the regulations of the particular regulatory region or country that has been determined by the reader controller 34. Preferably, more than one such downlink channel may be probed to reinforce confidence that the correct country or region in which the base station 40 and, in turn, the reader 10 are situated, has been identified.

As described herein, the country or region where the reader 10 is operated is identified by passively probing (only listening, and not transmitting) on at least one active GSM downlink channel, and by decoding the broadcast message on such a GSM downlink channel to obtain the country or region of operation of the nearby base station 40 that transmitted the broadcast message. By only having the RF module 32 listen, and not transmit, this disclosure will not violate any regulatory or privacy concerns (no decryption of voice or data packets, or any probe on control packets).

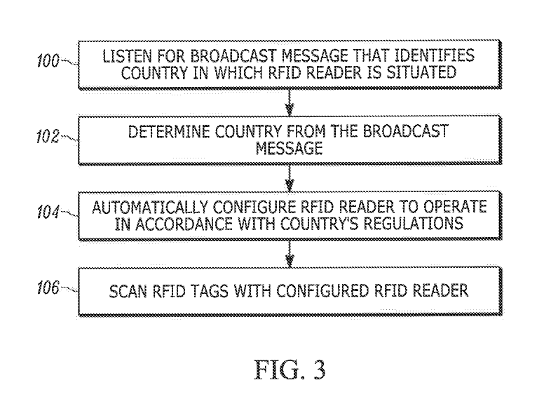

As summarized in the flow chart of FIG. 3, the method of configuring the RFID reader 10 to scan RFID tags in compliance with the regulations of a particular regulatory region or country of operation, is performed by initially listening for, and receiving, over a wireless channel, a broadcast message that identifies the particular regulatory region in which the reader 10 is situated (step 100), by determining the particular regulatory region in the received broadcast message (step 102), and by automatically configuring the reader 10 to operate in accordance with the regulations of the particular regulatory region upon such determination (step 104). Once the reader 10 has been configured, it is now able to correctly read RFID-tagged items (step 106).

In the foregoing specification, specific embodiments have been described. However, one of ordinary skill in the art appreciates that various modifications and changes can be made without departing from the scope of the invention as set forth in the claims below. For example, this disclosure is not intended to be limited to GSM networks, since other wireless networks, such as a code division multiple access (CDMA) network, a long term evolution (LTE) network, a terrestrial trunk radio (TETRA) network, etc., each of which also broadcast a country identifier from their base stations, can also be employed. The term “scan” as used in the specification and the claims is intended to cover any interaction between the reader 10 and the RFID-tagged items, including, but not limited to, reading, writing, locking, killing, and like interactions. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. An arrangement for configuring a radio frequency (RF) identification (RFID) reader to scan RFID tags in compliance with regulations of a particular regulatory region of operation, the arrangement comprising:
an RF module in the reader for listening for, and for receiving, over a wireless channel, a broadcast message that identifies the particular regulatory region in which the reader is situated; and
a controller in the reader for determining the particular regulatory region in the received broadcast message, and for automatically configuring the reader to operate in accordance with the regulations of the particular regulatory region upon such determination.

2. The arrangement of claim 1, wherein the RF module listens and receives the broadcast message over at least one Global System for Mobile communications (GSM) downlink channel, and wherein a base station periodically transmits the broadcast message over the at least one GSM downlink channel.

3. The arrangement of claim 2, wherein the RF module is operative for receiving the broadcast message in a range of frequencies from about 860 MHz to about 960 MHz.

4. The arrangement of claim 1, wherein the broadcast message contains a plurality of data fields, and wherein one of the data fields is a mobile country code identifier, and wherein the controller extracts the particular regulatory region from the mobile country code identifier.

5. A self-configuring radio frequency (RF) identification (RFID) reader operative for scanning RFID tags in compliance with regulations of a particular regulatory region of operation, the reader comprising:
an RF module in the reader for listening for, and for receiving, over a wireless channel, a broadcast message that identifies the particular regulatory region in which the reader is situated; and
a controller in the reader for determining the particular regulatory region in the received broadcast message, and for automatically configuring the reader to operate in accordance with the regulations of the particular regulatory region upon such determination.

6. The reader of claim 5, wherein the RF module listens and receives the broadcast message over at least one Global System for Mobile communications (GSM) downlink channel, and wherein a base station periodically transmits the broadcast message over the at least one GSM downlink channel.

7. The reader of claim 6, wherein the RF module is operative for receiving the broadcast message in a range of frequencies of about 860 MHz to about 960 MHz.

8. The reader of claim 5, wherein the broadcast message contains a plurality of data fields, and wherein one of the data fields is a mobile country code identifier, and wherein the controller extracts the particular regulatory region from the mobile country code identifier.

9. A method of configuring a radio frequency (RF) identification (RFID) reader to scan RFID tags in compliance with regulations of a particular regulatory region of operation, the method comprising:
listening for, and receiving, over a wireless channel, a broadcast message that identifies the particular regulatory region in which the reader is situated;
determining the particular regulatory region in the received broadcast message; and
automatically configuring the reader to operate in accordance with the regulations of the particular regulatory region upon such determination.

10. The method of claim 9, wherein the listening and receiving of the broadcast message is performed over at least one Global System for Mobile communications (GSM) downlink channel, and periodically transmitting the broadcast message over the at least one GSM downlink channel.

11. The method of claim 10, wherein the receiving of the broadcast message is performed in a range of frequencies of about 860 MHz to about 960 MHz.

12. The method of claim 9, and configuring the broadcast message to contain a plurality of data fields, and providing one of the data fields with a mobile country code identifier, and extracting the particular regulatory region from the mobile country code identifier.
